(19) United States
(12) Patent Application Publication
(10) Pub. No.: US 2007/0196113 A1
(43) Pub. Date: Aug. 23, 2007

(54) Monolithic optically preamplified coherent photoreceiver arrays

(76) Inventors: Ayub M. Fathimulla, Forest Hill, MD (US); Olaleye Adetoro Aina, Columbia, MD (US); Harry Stephon Hior, Sykesville, MD (US)

Correspondence Address: Hung Chang LIN, 8 Schndler Ct., Silver Spring, MD, 20903, US

(21) Appl. No.: 11/349,624

(22) Filed: Feb. 9, 2006

(51) Int. Cl. H04B 10/06

(52) U.S. Cl. 398/212

(57) ABSTRACT

An array of coherent phototoreceivers is constructed as an imager. Each photoreceiver comprises a local oscillator, a detector (mixer), an optical preamplifier (amplifier) and an electronic amplifier (TIA). A vertical cavity optical amplifier (VCSOA) is used either as the mixer or the preamplifier. The optical IF signal can be phase-shifted by 180° and detected to combine with the detected in-phase optical IF signal to obtain a balanced detector. The detector may use an avalanche photodiode with a trans-impedance amplifier for power reduction and higher gain.

### BACKGROUND OF THE INVENTION

1. Field of the Invention:

This invention relates to optical communications, particularly to monolithic optically preamplified coherent photoreceiver array.

2. Brief Description of Related Art:

The realization of imaging coherent ladar for extreme standoff engagement has been hampered by the unavailability of ultrasensitive photoreceivers. While it is possible to achieve near-shot-noise-limited performance with single-pixel coherent photoreceivers, it is usually at the cost of a high local oscillator (LO) power^{(1,2)}. For the large format arrays needed for high resolution imaging ladar, coherent photo receivers are impractical because the high L/O power results in a prohibitively high operating power for the array. For example, for a 100 MHz coherent receiver using an avalanche photodiode (APD) with a 1.0 nA dark current, the required L/O power to achieve shot noise limited signal-to-noise ratio (SNR) of 51 dB is 10 mW. When implemented as a 1000 element coherent array, the operating power will be impractical at the 10 W levels.

The approach usually employed to minimize the required LO power of coherent receivers is to try and eliminate the detector noise sources^{(3,4)}. This typically includes reducing the dark current at the expense of the responsivity and the fill-factor. For example in one approach involving the use of guard rings to reduce the dark current to less than 10 nA, the fill-factor is less than 50%⁽²⁾. Clearly, for the required SNR, L/O power and sensitivity of coherent receivers, new approaches to the receiver architecture are needed.

### SUMMARY OF THE INVENTION

An object of this invention is to develop an optically preamplified coherent photoreceiver to increase the SNR by two orders of magnitude while reducing the L/O power by one order of magnitude. Another object of this invention is to develop an imaging coherent photoreceiver array.

These objects are achieve by monolithically integrating a vertical cavity semiconductor optical amplifier (VCSOA) as disclosed in U.S. Pat. No.6,987,306 and an APD to amplify both the LO and the received optical power. As a result, a lower L/O power is required to cancel out all the noise sources including thermal and shot noise as well as the added noise amplified spontaneous emission (ASE) due to the optical amplifier. Additionally, the optical preamplification reduces the transmit power of the laser (ex: ladar system).

The benefits of the VCSOA preamplified coherent receiver are that its production is totally monolithic and it can be implemented as an array as shown in FIGS. 1 and 2. Furthermore, because the VCSOA is a surface-input device, fiber coupling is facilitated and coupling losses, which can be high with other types of optical amplifiers such as erbium-doped fiber amplifier (EDFA) and in-line semiconductor optical amplifier (SOAs) are minimized.

An integral part of this optically preamplified coherent photoreceiver invention is the improvement of the APD material and device structures. The current approaches such as guard rings to reduce the dark current of the APDs also degrade the responsivity and the fill-factor. In this invention, we propose a step graded junctions (mesas) to more evenly distribute the electric fields in the APD and reduce the dark current, while also increasing the fill-factor. This invention also cover the use of AlInAs/GaAsSb, AlGaAsSb/GaInAs material structures which are type II heterojunction, and the APD can be designed to have either hole injection or electron injection and which provide flexibility in the selection of the ionization k-factor to lower the noise equivalent power.

This invention can be extended to coherent photoreceivers and imaging ladar systems and components at mid-IR (2.0-4.0 μm) wavelengths because it is a more lossless and eyesafe spectral region than the near-IR (1.5 μm). There is a dearth of mid-IR ladar systems and components because the material and device technologies for mid-IR components are relatively immature as compared with near-IR components. Therefore, this invention also covers new mid-IR material and devices based on Thallium compounds such as TlInP, TlInAs, TlGaInSb and TlInSb. These materials have superior mid-IR electronic and optical properties such as higher electron mobilities and high ionization coefficient, which enables high performance lasers, optical amplifiers and detectors to be realized with them.

### BRIEF DESCRIPTION OF THE DRAWINGS

FIG. 1 shows a conceptual sketch of optically preamplified photoreceiver.

FIG. 2 shows a VCSOA conceptual sketch.

FIG. 3 shows a conceptual sketch of coherent photoreceiver.

FIG. 4 shows a block diagram of an optically preamplified coherent photoreceiver.

FIG. 5 shows details of optically preamplified photoreceiver block diagram.

FIG. 6 shows a block diagram of a balanced photoreceiver.

FIG. 7 shows a block diagram of an optically preamplified balanced photoreceiver.

FIG. 8 shows the schematic of the quartz phase plate that will be used to provide the required phase shift for the optically preamplified balanced photoreceiver

FIG. 9 shows the layout of 4×4 photoreceiver array.

FIG. 10 shows the use of VCSOA as an electro-optical mixer.

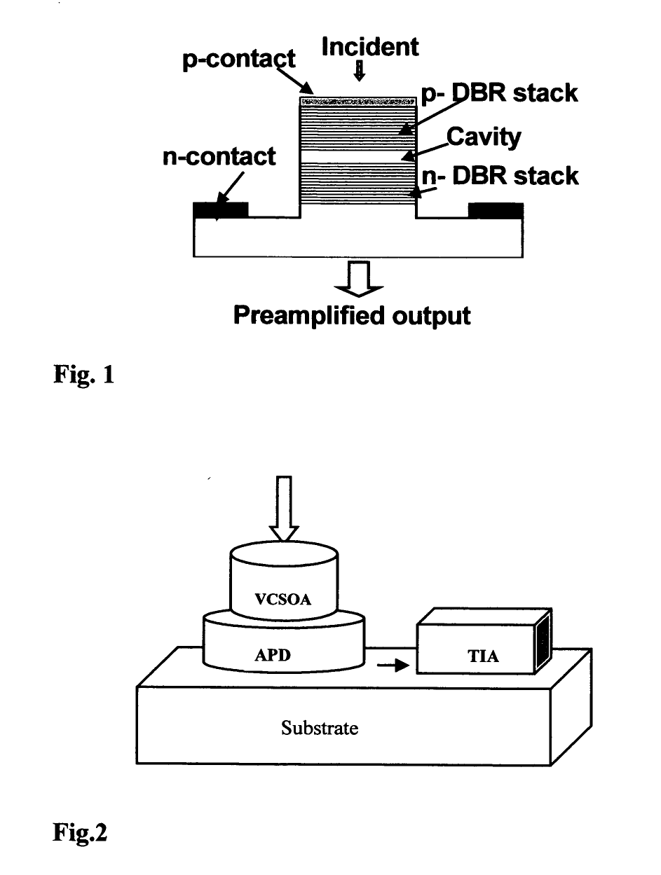

### DETAILED DESCRIPTION OF THE INVENTION

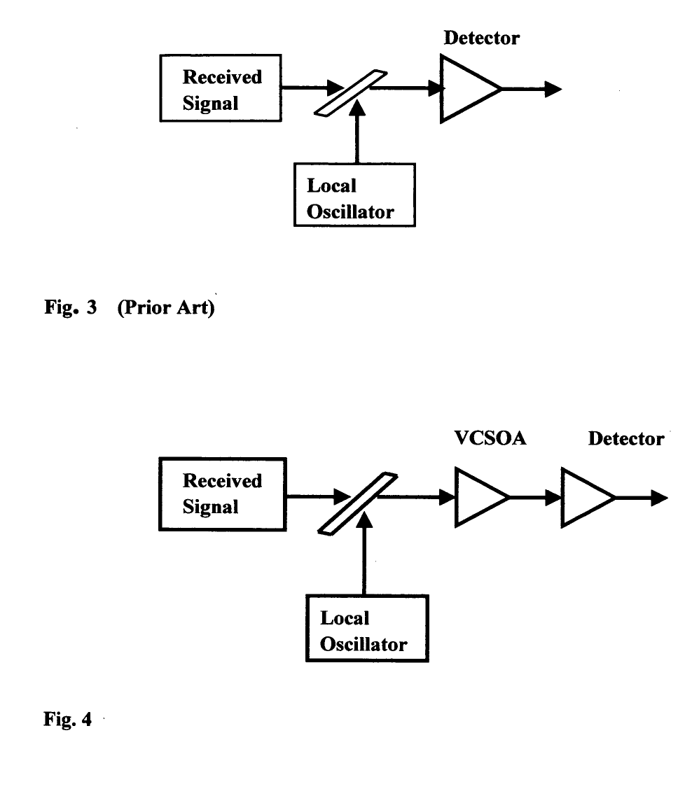

In a conventional coherent photoreceiver whose block diagram is shown in FIG. 3, the received optical signal is mixed with the local oscillator to generate the difference frequency signal given by⁽¹⁾:
i_{sig}=RPᵣ+RP_{LO}+2R\sqrt{PᵣP_{LO}} Cos [(ω_{r-ω}_{LO})t+φ] (1)
where R is the detector responsivity, Pᵣ is the received optical power, P_{LO} is the local oscillator power, ωᵣ and ω_{LO} are the signal and L/O frequencies respectively. The third term of eq. 1 which is the multiplication of the signal and the L/O is the coherently received signal while the first two terms which are the base-band and DC components are filtered out. The output SNR is given by⁽¹⁾:

$${SNR}_{coherent} = \frac{{R}^{2} {P}_{lo} {P}_{r}}{( {qRP}_{LO} + {P}_{therm\_noise} + {P}_{shot\_noise} ) B} \qquad ( 2 )$$

where q is the electronic charge and B is the electronic bandwidth. At high L/O powers, the receiver is shot noise limited and its SNR is highest. The required L/O power for shot noise limited performance is ˜10 mW which results in a 1-W power dissipation for a 1000-element array.

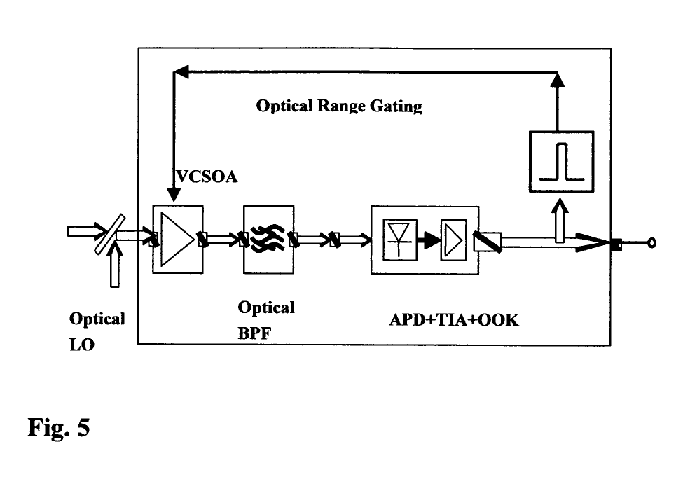

Our proposed optically preamplified coherent photoreceiver involves inserting an optical amplifier in the signal stream as shown in FIG. 4 in such a way that the optical signal and the LO power are amplified with the generation of amplified spontaneous emission (ASE).

The SNR for the optically preamplified coherent receiver is now given by:

$${SNR}_{coherent\_preamplified} = \frac{{G}^{2} {R}^{2} {P}_{lo} {P}_{r}}{( {qRP}_{LO} + {P}_{therm\_noise} + {P}_{shot\_noise} + {P}_{ASE} ) B} \qquad ( 2 )$$

where G is the optical amplifier gain and the P_{ASE} is the ASE noise power. The optical pre-amplification enhances the SNR by at least two orders of magnitude. As with conventional coherent receivers, the L/O power can be used to counteract the noise sources as well as the ASE noise. The key difference now is that shot noise limited performance can be achieved at much lower L/O powers. The block diagram for the proposed optically preamplified coherent photoreceiver is shown in FIG. 5.

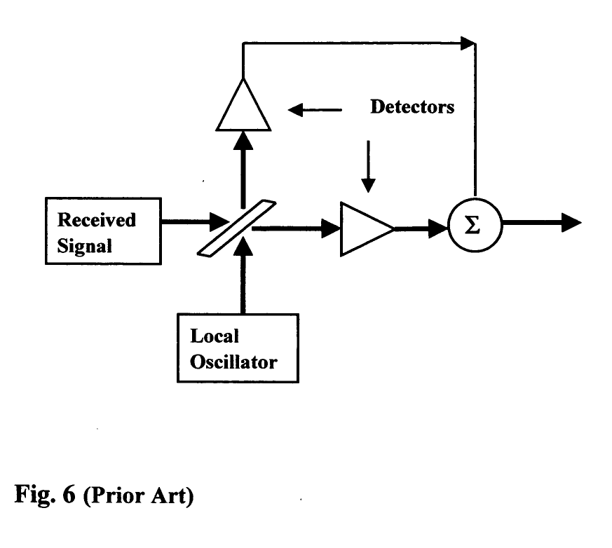

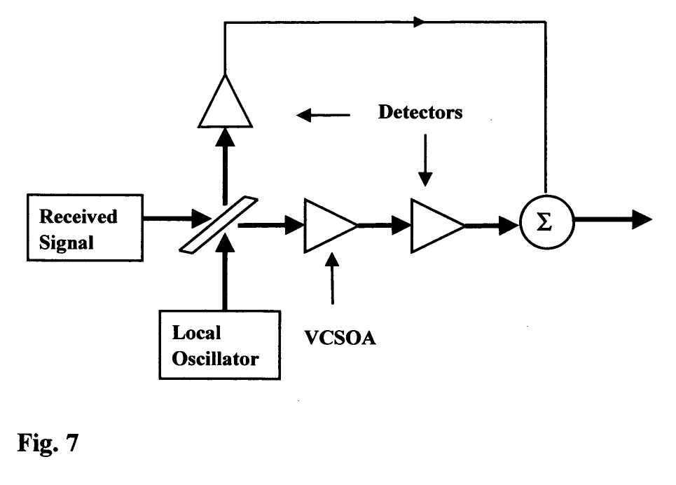

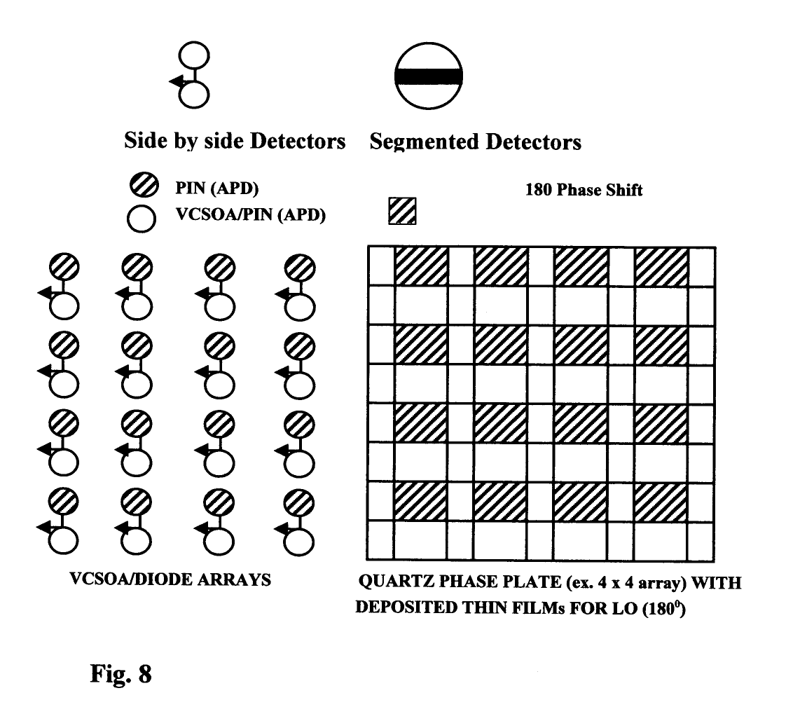

The implementation of balanced detection is shown in the FIG. 6, in which two detectors are placed side by side. A single segmented detector can also be used. The local oscillator light incident on the detector or on one segment is phase shifted by 180°. In the conventional balanced detection technique fibers are used to provide the required phase shift. In particular, the detectors require: 1) equalization of both electrical and optical path lengths, 2) balanced quantum and coupling efficiencies, and 3) matched bandwidths and sensitivities. Our proposed optically preamplified balanced photoreceiver involves inserting an optical amplifier in one of the signal stream as shown in FIG. 7. In this invention for the balanced detection, the phase shift is provided by thin films deposited on quartz plate as shown in the FIG. 8 for the detector arrays.

The advantages of balanced detection are:
1) Canceling of the LO intensity noise for higher sensitivity
2) Decrease in LO power
3) Decrease in quantum noise of the LO
4) Shot noise limited performances

Another aspect of the invention is the use of the thin films deposited on quartz plate (shown in FIG. 8) to provide the required phase shift for both optically preamplified coherent photoreceiver and conventional coherent photoreceivers.

Optically Preamplified Coherent Photoreceiver Array

Our proposed approach to implement the optically preamplified photoreceiver array is to monolithically integrate VCSOAs with APDs as shown in FIG. 2. The approach builds on technologies previously disclosed in U.S. Pat. No. 6,987,306. With the VCSOAs, optical gains up to 30 dB and noise figures lower than 5 dB are possible. The DBR mirrors of the VCSOAs act as effective filters to minimize the ASE noise.

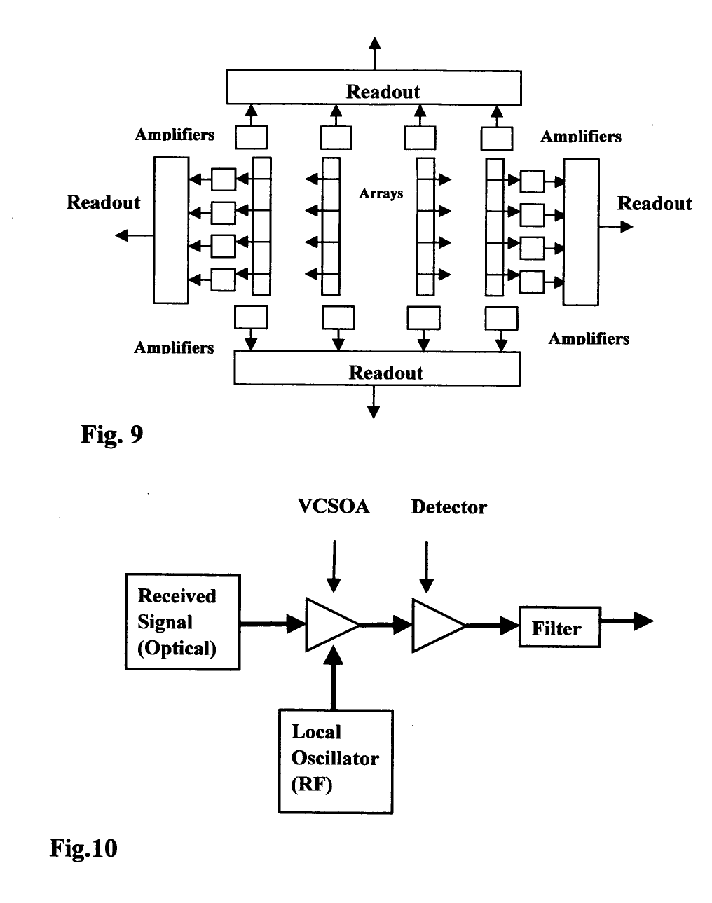

A notional layout of an N×N (4×4) optically preamplified arrays using photoreceivers (shown in FIGS. 4 and 7) is shown in FIG. 9. Each pixel will typically have diameter of 50 μm with 25 μm spacing between pixels. This will result in a 2.5×2.5 mm aperture and a 75% fill-factor for a 1000-element array. Further, the fill-factor can be enhanced up to 250% using micolens arrays to allow fill-factors approaching 100%. The amplifiers, A/D converters and the rest of the readout circuits are placed outside the optically active area For the proposed monolithic, N×N (4×4) optically preamplified, coherent photoreceiver, we estimate SNR at least two orders of magnitude higher and L/O power one order of magnitude lower than conventional coherent photoreceivers.

The material systems AlInAs/AlGaAsSb and AlAsSb/AlGaInAs, selected for the N- and P-mirror ΔE [symbol] of the optical amplifier result in low band gap discontinuity, _{c} in the conduction band and ΔEᵥ in the valence band respectively, which result in lower series resistance. Further, the largest refractive index difference is obtained using the AlAsSb/GaInAs and AlAsSb/GaAsSb material system as compared to the widely used InP/GaInAsP and therefore requires fewer mirror layers to achieve high reflectivities in the long wavelength band. Since the width of the reflection band is linearly proportional to Δn, a wider band can also be achieved with these mirrors.

The heterostructure design of the avalanche photodiode (APD) can be optimized for high quantum efficiency, high speed, high responsivity and lower dark currents. The higher speed of the photodiode can be achieved by using thinner absorption layers at the cost of sacrificing the responsivity. This trade-off can be achieved by using resonant cavity structures to increase the quantum efficiency without compromising the speed. With this, the resulting cavity is wavelength selective which is most desirable for LADAR applications.

Novel material structures have been proposed in the U.S. Pat. No. 6,987,306 for Resonant-Cavity-Enhanced Separate Absorption, Charge and Multiplication region (RCE-SACM) avalanche photodiode utilizing antimony-based mirrors for applications in imaging LADAR operating at 1.5 μm. The detector structures are based on using GaAsSb or GaInAs as absorption layers, AlGaAsSb and AlInAs as the multiplication layers and Al₁₋ₓGaₓAsSb/AlInAs (p-type) and Al₁₋ₓGaₓInAs/AlAsSb (n-type) reflectors as the filter and also to increase quantum efficiencies. The proposed antimony-based mirrors require much fewer layers without compromising the APD performance. It reduces the cost of RCE-APD wafers, simplify receiver manufacturing and lower the overall cost of producing the receivers. In addition, the built-in mirror reduces the background light from the sun, moon and stars.

Our proposed AlAsSb, AlGaAsSb, GaAsS, GaInAs and AlInAs materials can be lattice ΔE [symbol] matched to InP. Because of the type II band lineup between AlGaAsSb and GaInAs (−ΔEᵥ), hole ΔE [symbol] injection into multiplication region dominates. Similarly, the conduction band discontinuity (ΔE_{c}) between AlInAs/GaAsSb is negligible and electrons can be injected into the multiplication layer. Therefore, APDs can be designed to have either hole or electron injection.

The reliability of the APDs has been the subject of studies by various scientists. For example, passivation and edge breakdown are the most important factors that affect the reliability of the APDs. In order to address the edge breakdown introduced by high electric fields, planar structures instead of mesas are used. However, the planar structure requires either a “guard ring” or beveled mesa (doping profile) to tailor the electric-field profile so that avalanche breakdown occurs in the central portion of the diode and not at the periphery. The price paid due to the guard ring or bevel edge is that the fraction of the chip area sensitive to light is limited and fill-factor is reduced. We propose stepped mesas (for each layer) to tailor the electric-field profile so that avalanche breakdown at the periphery is minimized and thereby increasing the reliability. Since the total mesas are less than 2.0 μm for the stepped mesas, as compared with 10 μm when a guard ring is used, our novel approach increases the fill-factor significantly.

Optical Preamplifier/detector as an Electro-optic Mixer:

Another aspect of the invention is the use of the optical preamplifier/detector as an electro-optic mixer as shown in FIG. 10. The incoming received optical signal is modulated by local oscillator (RF signal) that is applied to the VCSOA. The mixing takes place due to the non-linearity in the detector.

Mid Wavelength IR Photoreceiver

Another aspect of the invention are low cost, high speed, low dark current, enhanced quantum efficiency and high sensitivity monolithic APDs and photoreceiver arrays with response in the mid-IR spectral range. To do this, we propose innovative combinations of new materials such as Thallium Phosphide (TIP), Thallium Arsenide (TIAs) and Thallium Antimonide (TlSb) having similar properties as Mercury Cadmium Telluride (MCT). Ternary and quaternary alloys of these semiconductors, such as Thallium Indium Arsenide (TlInAs) and Thallium Gallium Indium Arsenide (TlGaInAs) as the absorption layer of the APD have high mobilties and the flexibility of tuning the band gap when grown on GaSb substrates. For example, APDs can be developed using narrow band gap alloys Tl_{0.12}In_{0.88}As (12.0 μm) and Tl_{0.25}GaIn_{0.75}As (l.5 μm) as absorption layers and SL of AlSb/AlGaSb, AlInAs/AlGaAsSb as multiplication layer for the APD on GaSb and InP substrates respectively.

An alternate detector material system for mid-IR operation is based on GaInAsSb/AlInAsSb, which exhibit type-I band alignment suitable to design low leakage current devices. We can use high differential refractive index layers of A₁₋ₓGaₓSb/A_{1-y}Ga_{y}Sb heterostructures mirrors, GaInAsSb/InSb absorbing layers and AlGaAsSb/AlInAsSb as multiplication layers. These structures can be grown on either GaSb or GaAs (InP) substrates using metamorphic buffer layers.

In another aspect of the present invention, the concept of optically preamplified coherent photoreceiver can be extended to other wavelengths covering ultra violet to very long wavelength infrared using the InP, GaAs, GaSb, InAs, InSb, SiGe, SiC and GaN etc. based technologies.

While the preferred embodiment of the invention have been described, it will be apparent to those skilled in the art that various modifications may be made to the embodiments without departing from the spirit of the present invention. Such modifications are all within the scope of the present invention.

### REFERENCES

1. Christopher T. Allen and Yanki Cobanoglu, “The Design and Development of a Hybrid RF/Laser Radar System for Measuring Changes in Ice Surface Elevation at Arctic Regions” NASA Technical Report # ITTC-RSL-FY2002-TR-18680-02, May 2002
2. H. Kressel, Editor, Semiconductor Devices for Optical Communication, Topics in Applied Physics, Vol. 39, Springer-Verlag, Berlin, 1982.
3. E. H. Putley, “Thermal Detectors,” in Optical and Infrared Detectors, R. J. Keyes, ed., Springer-Verlag, Berlin, 1980
4. K. J. Williams, R. D. Esman, IEEE Photonics Letters, Vol. 8, #1, p.148, 1996.

1. An optically preamplified coherent photoreceiver, comprising:
a local oscillator for generating a local oscillator frequency signal;
a detector (mixer) for mixing a received signal with said local oscillator frequency signal to produce an in-phase intermediate frequency (IF) signal;
an optical preamplifier, wherein a vertical cavity semiconductor optical amplifier (VCSOA) is selected for use between said detector (mixer) and input light; and
a TIA to amplify and to obtain an in-phase detected signal.

2. The optically preamplified coherent photoreceiver as described in claim 1, wherein said VCSOA is used in said optically preamplifier, further comprising:
a 180° phase shifter to phase shift said in-phase optical signal and to generate an out-of phase optical signal,
an out-of-phase detector to detect said out-of-phase optical signal to obtain an out-of-phase detected signal, and
a summer to add said in-phase detected signal with said out-of-phase detected signal to form a balanced photoreceiver.

3. The optically preamplified coherent photoreceiver as described in claim 2, wherein said 180° phase shifter is implemented by thin films deposited on a quartz-plate.

4. The optically preamplified coherent photoreceiver as described in claim 1, wherein said detector comprises an avalanche photo diode and a trans-impedance amplifier (TIA)

5. The optically preamplified coherent photoreceiver as described in claim 4, wherein said avalanche photodiode is selected from the group consisting of a GaAsSb, GaInAs absorption layers and AlInAs, AlGaAsSb, InP multiplication layers.

6. The optically preamplified coherent photoreceiver as described in claim 5, wherein said avalanche photodiode has step graded mesas.

7. The optically preamplified coherent photoreceiver as described in claim 1, further comprising a plurality of said photoreceiver to form an array.

8. The optically preamplified coherent photoreceiver as described in claim 1, wherein said detector is selected from the group consisting of a PIN diode and an avalanche photodiode, photoconductor, bolometer, and PMT.

9. The optically preamplified coherent photoreceiver as described in claim 1, wherein said IF amplifier is a trans-impedance amplifier (TIA).

10. The optical preamplifier coherent photoreceiver as described in claim 1, wherein said VCSOA, detectors, TIA, clock and digital converter are monolithically integrated on a single wafer.

11. The optical preamplifier coherent photoreceiver as described in claim 10, wherein said photoreceiver is extensible to wavelengths covering ultra violet to very long wavelength infrared using semiconductor material selected from the group consisting of InP, GaAs, GaSb, InAs, InSb, SiGe, SiC and GaN.

12. The optical preamplifier as described in claim 1, wherein said photoreciever is used as an electro-optic mixer.

13. The optical preamplifier coherent photoreceiver as described in claim 1, wherein said photoreceiver is used for mid-wavelength infrared using thallium compounds selected from the group consisting of TIP, TIAs, TlSb, TlInAs, and TlGaInAs.
